(19) United States
(12) Patent Application Publication
(10) Pub. No.: US 2017/0148267 A1
(43) Pub. Date: May 25, 2017

(54) CELEBRITY CHASE VIRTUAL WORLD GAME SYSTEM AND METHOD

(71) Applicant: Joseph William PARKER, Houston, TX (US)

(72) Inventor: Joseph William PARKER, Houston, TX (US)

(21) Appl. No.: 14/952,461

(22) Filed: Nov. 25, 2015

(51) Int. Cl. G07F 17/32

(52) U.S. Cl. CPC G07F 17/3255; G07F 17/3295; G07F 17/3206; G07F 17/323; G07F 17/3269; G07F 17/3209

(57) ABSTRACT

Systems and methods for providing a celebrity chase virtual world game are disclosed. In the virtual world game, users compete against programmed game logic and/or other users to collect autographs and pictures of virtual celebrities for game credits. Various game mechanics enable a player to disable an obstructing avatar, or to impede another player's progress. For example, one player may use a virtual camera flash to temporarily blind a bot trying to block their path toward a virtual celebrity, or use it on another player, during which the programmed avatar and/or other player is impeded from pursuing the virtual celebrity. In other instances, the impeded player may continue to navigate the virtual world, but be prevented from pursuing the virtual celebrity for a predefined duration of time. Once a virtual celebrity is captured by a player, the player may collect a virtual autograph and “selfie” picture with the virtual celebrity.

### FIELD OF THE DISCLOSURE

This disclosure relates to systems and method of providing a virtual world game where users compete against artificial intelligence of the game and/or other users to collect autographs and pictures of virtual celebrities for game credits.

### BACKGROUND

Various virtual worlds and games exist. None are believed to provide the features and functions of the invention.

### SUMMARY

One aspect of the invention comprises a virtual world game where users attempt to capture a virtual celebrity (e.g., an in-game representation of a real or fictional celebrity) for game credits. The term “capture” means to perform a task with respect to a virtual celebrity. The task, as described in non-limiting examples throughout this disclosure, may include obtaining a virtual autograph from the virtual celebrity, taking a virtual “selfie” picture with the virtual celebrity, and/or performing other actions with respect to the virtual celebrity.

The virtual world game may be played in a single player mode in which a user competes against game logic in a game-controlled environment (e.g., game-controlled non-player characters—also known as “bots,” game-controlled objects such as obstacles, etc.) with no other human-controlled avatars present in the game-controlled environment. Alternatively or additionally, the virtual world game may be played in a multi-player mode in which a user competes against other users to capture a virtual celebrity for game credits. For instance, in a multi-player mode, players may compete against other players to track down the virtual celebrity and collect autographs and/or pictures before other players have collected such autographs and/or pictures from the virtual celebrity. In some instances of multi-player gameplay, users may compete against both other users and the game logic. Various game mechanics enable a player to impede a game-controlled bot and/or another player. The accumulated game credits can be redeemed for gift cards, promotional items, discount coupons and other items.

According to one aspect of the invention, once in the virtual destination, players can choose from a listing of virtual celebrities regarding whom they choose to perform a task (e.g., from whom they want to seek an autograph or with whom they want to take a virtual “selfie” picture). An expandable grid map shows where the celebrities are in relationship to the player's location in the virtual world. Selecting a particular celebrity's location causes a display of celebrity related information (e.g., a bio of the celebrity and how many game credits players will receive for completing the task). Each player and each celebrity may be represented by an avatar. Celebrities may be identified by a visual designation (e.g., a star floating above them) which is easily seen by players in the virtual world.

After choosing a celebrity and/or task, the computer will point in the directions that the player must guide their avatar to intercept the chosen celebrity avatar. Using a control screen, the player can steer their avatar through the virtual world populated with other players' avatars looking for celebrities. The grid map will also show which other avatars are looking for the same celebrity.

Players may have equipment and/or accessories that they can acquire and use in the virtual world. As part of the strategy and game mechanics, players can choose actions to impede another player's progress. For example, a player may use the flash from their avatar's camera to temporarily blind other avatars within a certain proximity when chasing celebrities. Using such mechanics may come at a price. For example, a player may have to pay to replenish a limited supply of flashes by going inside virtual businesses or by acquiring game credits. When an avatar is temporarily blinded by another avatar, the blinded avatar may be “disabled” for a period of time (e.g., 5 Seconds). According to another aspect, at the end of the period of time, the blinded avatar may receive additional energy and the attacking avatar may lose energy. According to another aspect, during these 5 second time-outs, the temporarily disabled avatar may be presented with content with which it must interact (e.g., may be required to view a brief video advertisement) before it can proceed in the virtual world.

Various in world businesses or stores may be provided. Inside any business or store, players can acquire equipment, accessories and/or other items. For example a user can earn game energy by clicking ‘Like’ and becoming real-world social media fans of that business or store.

According to another aspect of the invention, players who run out of energy are still able to socialize, but not chase after celebrities until they re-energize by entering a store or using game credits.

Various mechanics may be provided to enable players to acquire energy or other in-world items in a way that enables the virtual world operator to monetize the world. For example a player can touch a picture of a vehicle or movie posters and take a brief virtual test ride or watch a short trailer that will earn them Bonus Energy.

According to another aspect of the invention, players can earn points by engaging in social activities in world (e.g., by greeting players and becoming friends).

The celebrity avatars may be programmatically operated. When a player's avatar gets close enough to see a gold star hovering over a celebrity on the control screen, the computer program may automatically launch a free mini movie. Mini movies may be different for each level and follow the two avatars on foot and in exciting chase scenes in cars, boats, airplanes, etc . . . . The mini movies end when the player's avatar follows a celebrity into a virtual store or business and the player resumes control of the avatar's movements as they play cat and mouse in aisles and offices. Whether inside or outside virtual buildings, various obstacles, bots, and evasive actions from the celebrity avatar may impede the pursuit. The pursuit ends when the cornered celebrity avatar surrenders and lets the player have an autograph and/or take selfie-pictures with them. Autographs and selfie-pictures are posted onto the player's wall of fame and their individual social media pages for their friends to see.

Players can go to the next game level and choose a better known and slightly more elusive celebrity to search for or check their game credit balance and browse the virtual store to redeem those credits for gift cards, promotional items or discount coupons.

According to another aspect an administrative module is operable to evolve the atmosphere and enhance the diverse scenery with interactive product placements, including demographic advertising for music, fashion, electronics, movies and other products. Demographically targeted advertising of products and services are presented in local, regional and national markets to consumers who can relate to them and respond positively. Virtual product placements (movies, music, fashion, electronics, cosmetics and vehicles) virtual businesses & store fronts (players receive energy for entering,) virtual logos (players receive credit for touching,) pay per click (when players ‘click’ on website,) pay per metric (pay per 1000 impressions,) pay per fan (when players click ‘like’ on ad,) 10 second audio-visual ads (watched regaining energy) 5 second audio-visual ‘slogan’ ads (watched when they click on logos and during time-outs) and virtual accessories (clothes, jewelry, improved skills and pets) that players can purchase to enhance their experience.

In stores, surveys and customer service ratings earn players bonus energy and camera flashes as they return to their adventures in the Virtual World.

According to another aspect of the invention, players may use virtual reality headsets to see the virtual world in all directions through the first person perspective of their avatar's eyes. Voice recognition interfaces may be used to control the movements of an avatar's mouth and eyes in real time when two or more players speak to each other in close proximity to mimic the synergy of a real conversation. Voice recognition interface may also be used to control an avatar's facial gestures in real time for actions such as ‘nodding’ for “yes” and ‘shaking head’ for “no.” A virtual reality headset may be connected to motion sensing virtual controls to enable a player to become completely immersed in the virtual world with full control of their actions. A virtual keyboard and hand controlled virtual cursors allow a player to navigate freely in the virtual world and communicate not only inside the program, but also with the outside world using Bluetooth® communication protocols (or other wireless devices).

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for providing a celebrity chase virtual world game, according to an implementation of the invention.

FIG. 2 is a block diagram that depicts an example of celebrity chase application, which provides a celebrity chase virtual world game to users, according to an implementation of the invention.

FIG. 3 illustrates a process for providing a celebrity chase virtual world game, according to an implementation of the invention.

FIG. 4 illustrates a process for conducting a chase in a celebrity chase virtual world game, according to an implementation of the invention.

FIG. 5 illustrates a screen shot of a control screen for navigating within a celebrity chase virtual world game, according to an implementation of the invention.

### DETAILED DESCRIPTION

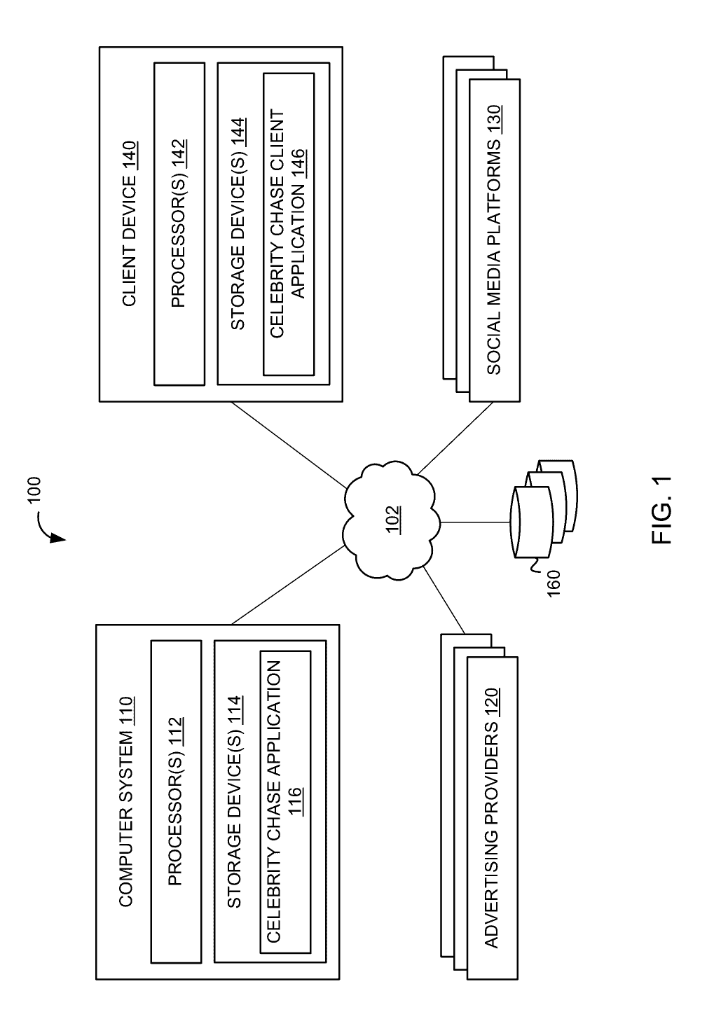

FIG. 1 illustrates a system 100 for providing a celebrity chase virtual world game, according to an implementation of the invention. In the virtual world game, users attempt to capture a virtual celebrity (e.g., an in-game representation of a real or fictional celebrity) for game credits. The term “capture” means to perform a task with respect to a virtual celebrity. The task, as described in non-limiting examples throughout this disclosure, may include obtaining a virtual autograph from the virtual celebrity, taking a virtual “selfie” picture with the virtual celebrity, and/or performing other actions with respect to the virtual celebrity. Various game mechanics enable a player to disrupt a game-controlled bot and/or impede another player's progress. As used herein, the terms “user” and “player” (including plural variants) are used interchangeably throughout, unless specifically described otherwise. The terms “celebrity avatar” and “virtual celebrity” will also be used interchangeably throughout, unless specifically described otherwise. The game credits can be redeemed for gift cards, promotional items, discount coupons, and/or other items.

Providing the virtual world may include hosting the virtual world over a network. In some implementations, system 100 may include a computer system 110. Computer system 110 may be configured to communicate with one or more end user devices 140. The users may access computer system 110 and/or the virtual world via end user devices 140.

Computer system 110 may be configured as a server, a desktop computer, a laptop computer, and/or other device that can be programmed to provide a celebrity chase virtual world game, as described herein. Computer system 110 may include one or more processors 112 (also interchangeably referred to herein as processors 112, processor(s) 112, or processor 112 for convenience), one or more storage devices 114 (which may store various instructions described herein), and/or other components.

Processors 112 may be programmed by one or more computer program instructions. For example, processors 112 may be programmed by a celebrity chase host application 116 and/or other instructions that program computer system 110 to perform various operations. As used herein, for convenience, the various instructions will be described as performing an operation, when, in fact, the various instructions program the processors 112 (and therefore computer system 110) to perform the operation.

End user device 140 may include one or more processors 142 (also interchangeably referred to herein as processors 142, processor(s) 142, or processor 142 for convenience), one or more storage devices 144 (which may store various instructions described herein), and/or other components. Processors 142 may be programmed by one or more computer program instructions. For example, processors 142 may be programmed by a celebrity chase client application 146 and/or other instructions that program end user device 140 to perform various operations. As used herein, for convenience, the various instructions in relation to the end user device will be described as performing an operation, when, in fact, the various instructions program the processors 142 (and therefore end user device 140) to perform the operation.

Celebrity chase client application 146 may be configured as a “mobile app” or other instructions that program end user device 140. For example, celebrity chase client application 146 may program the end user device to allow the user to interact with computer system 110 and the virtual world game described herein. For instance, celebrity chase client application 146 may program the end user device to receive inputs from a user and convey the inputs to computer system 110 for playing the virtual world game.

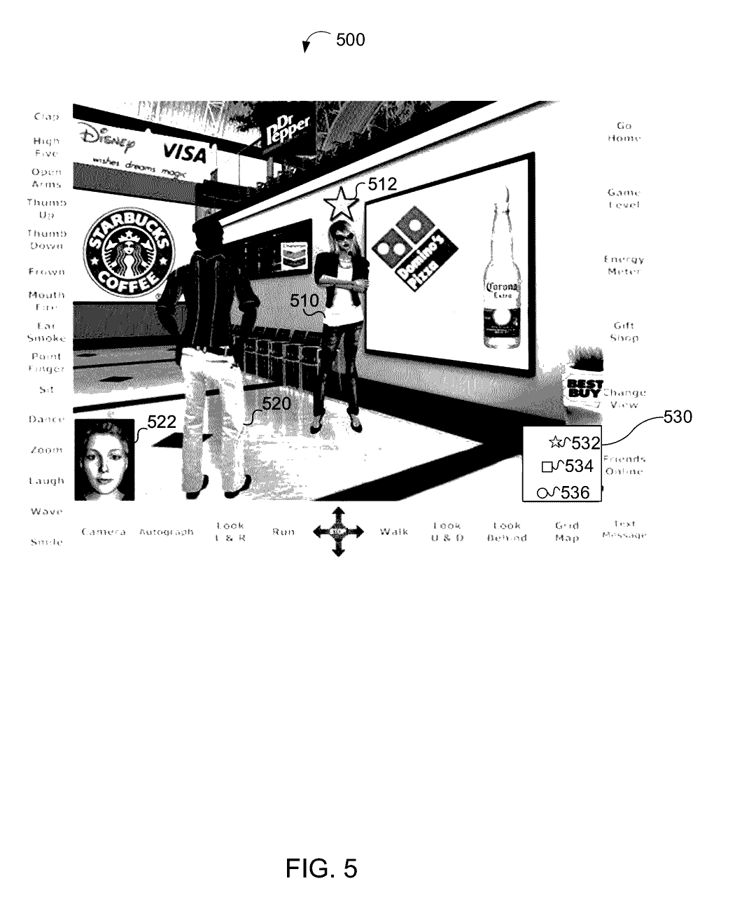

Celebrity chase client application 146 may program end user device 140 to provide a control screen, such as the user interface illustrated in FIG. 5. Control screen may provide various inputs such as a mouse cursor, one or more soft keys, and/or other user interface members to click onto objects visible on the control screen to obtain information on products and services, contact other players who they want to meet, and interact with the virtual world.

In some instances, a virtual keyboard and hand controlled virtual cursors allow a player to navigate freely in the virtual world and communicate not only inside the program, but also with the outside world using Bluetooth® enabled cellular devices.

In some implementations, end user device 140 may be configured as or be communicably coupled to a Virtual Reality Headset (“VRH”) connected to motion sensing virtual controls that enable a player to become completely immersed in the virtual world with full control of their actions.

Celebrity chase database 160 may be configured to store information related to the features and functions described herein. For instance, celebrity chase database 160 may store information relating to avatar templates, game levels, celebrity avatars, game logic, game accounts, player profiles, player financial accounts, and/or other information.

Having described a high level overview of examples of functions and operations of system 100, attention will now be turned to a description of celebrity chase host application 116.

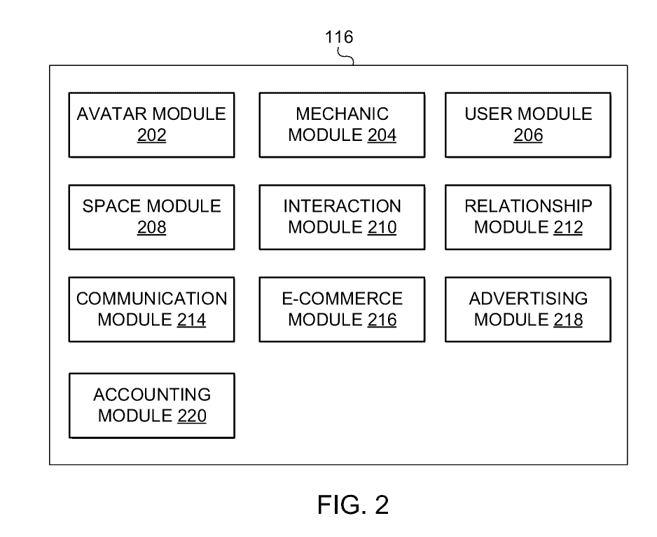

FIG. 2 is a block diagram that depicts an example of celebrity chase host application 116, which provides a celebrity chase virtual world game to users, according to an implementation of the invention. Celebrity chase host application 116 may include one or more sets of instructions, described herein as modules for convenience, that program computer system 110. Celebrity chase host application 116 may include, for example, an avatar module 202, a Game module 204, a user module 206, a space module 208, an interaction module 210, a relationship module 212, a communication module 214, an electronic commerce (“e-commerce”) module 216, an advertising module 218, and/or other instructions.

Generating and Manipulating Avatars

Players may select, create, customize, or otherwise specify an avatar that represents them in the virtual world game. For instance, avatar module 202 may obtain a digital image of a player (e.g., a photo of the player's actual face), which may be uploaded by the player. Avatar module 202 may receive a selection of a body type or a selection (by the player) of a template avatar. Avatar module 202 may generate a player's avatar based on the digital image, body type, template, and/or other information that can be used to alter the appearance of an avatar.

Avatar module 202 may provide a list of avatars (which may or may not later be customized by the player). Some of the selectable avatars may be offered free of charge, while others may require payment in real currency, virtual currency, or other object of perceived or actual value. Once the player's avatar has been generated (whether based on a digital image of the player, a body type, a template avatar, customizations, etc.), avatar module 202 may store an association between the player's avatar and a game account associated with the player. The game account may store information relating to the player, such as a real name, player demographics, payment information (e.g., credit card information), etc.

Avatar module 202 may provide a player with a virtual home that may be decorated and upgraded. Such upgrades may be provided when the user reaches certain game levels and/or through payment of virtual or real currency.

Avatar module 202 may provide other virtual objects that may be earned or purchased, such as, without limitation, items that can assist the player during gameplay, clothing, jewelry, accessories, pets, and/or other virtual objects. Items that can assist the player during gameplay may include, without limitation, different virtual cameras that enable the player to take virtual pictures of celebrity avatars from different distances, virtual shoes that allow the player's avatar to run faster or slower, and/or other items that can enhance (or decrease) a player avatar's ability to capture a celebrity avatar.

In some instances, each player avatar may be associated with a set of virtual abilities. The virtual abilities may include, without limitation, a speed with which the player's avatar can traverse the virtual world, an agility (e.g., to dodge virtual obstacles), and/or other virtual abilities. The virtual abilities may be enhanced when the user reaches certain game levels and/or through payment of virtual or real currency.

Avatars can approach each other to make a variety of hand gestures or facial expressions and use a Voice-Over IP to speak directly to each other.

In an implementation, avatar module 202 may include a visual or voice recognition interface that controls the movements of an Avatar's mouth and eyes in real time when two or more players speak to each other in close proximity which mimics the synergy of a real conversation.

For instance, automated speech recognition techniques may be applied to voice input by the player (e.g., when the player is having a conversion with another player through respective avatars in the virtual world). The voice recognition interface may obtain text recognized from the voice input and control a player's avatar based on the obtained text. For instance, avatar module 202 may control facial gestures in real time for actions such as ‘Nodding’ for obtained text that includes “Yes” and ‘Shaking head’ for obtained text that includes “No.” Other types of recognized text may result in other avatar actions/movements as well.

In an implementation, avatar module 202 may allow a player to obtain information about another player through their avatars. For instance, when a player clicks onto or otherwise selects another avatar, player information (e.g., Name, Age Location, etc.) for a corresponding player may be obtained (subject to any privacy settings that the corresponding player has set). Avatar module 202 may cause an information bubble to be displayed to the first player. The information bubble may display the player information unless the chosen player does not want their identity known to the public without a request and disables that function. Alternatively or additionally, players may click on the information bubble and obtain the corresponding player's social media handles and make a friend request.

Modes of Play

In an implementation, once a player has selected and/or customized an avatar, the player may select different modes of gameplay. The different modes of gameplay may include, without limitation, a level-based mode, a free-form mode, and/or other modes. The level-based mode may include a plurality of levels, each of which may be associated with its own level of difficulty. For instance, in this mode, a player may progress through different levels as objectives are achieved. Each level may be associated with different celebrity avatars to capture. Levels may become progressively harder (e.g., celebrity avatars may become more difficult to capture). Each level may associated with a predefined set of one or more celebrity avatars to capture or may be associated with a selectable listing of celebrity avatars that the player may choose to attempt to capture for that level. In some instances, each level may include other players who are also competing in that level.

In a free-form mode, any player may play and compete against the game's artificial intelligence and/or other players. In some instances, the free-form mode may also provide players with a selectable listing of celebrity avatars that may be selected by the player to chase. In some instances, players in the free-form mode may be matched with other players who are playing in the free-form mode. Such matching may be based on common celebrity avatars that each player has chosen to pursue. In other instances, players in the free-form mode may be matched with any other player (who may be pursuing the same or different celebrity avatars). In yet other instances, the player may compete against the artificial intelligence with no other players.

Gameplay

Game module 204 may instantiate the virtual world (e.g., via space module 208) and control various aspects of the virtual world game. For instance, game module 204 may present a selectable listing of virtual worlds that a player may select to conduct a virtual celebrity chase.

Initiating a Chase and Selecting and Locating a Celebrity Avatar

In some instances, a given chase may require a certain amount of “energy.” Players who run out of energy may still be able to socialize and interact within the virtual world, but not chase after virtual celebrities until they re-energize by entering a store, using game credits, purchasing energy, waiting for energy to be replenished for free, and/or performing other actions.

In some instances, energy may be earned by in various ways. For instance, energy may be accrued over time without any player interaction. In some instances, a player may earn energy by performing certain actions within the virtual world. For example, the player may enter a virtual business or store to earn energy. The player may click a ‘Like’ in relation to the store to earn bonus energy (e.g., energy in addition to the energy for entering the store). The player may also become social media fans of that business or institution to earn energy.

In some instances, players can touch a picture of vehicle or movie posters within the virtual world and take a brief virtual test ride or watch a short trailer that will earn them energy. Players can earn points by greeting players and becoming friends, or inviting others to play the game. Other ways to earn energy (e.g., purchase using real or virtual currency) may be provide as well.

In an implementation, if a player has sufficient energy, the player may choose from a listing of virtual celebrities for which they must complete a task (e.g., obtain a virtual autograph, take virtual selfie-picture with, and/or complete other tasks). Different celebrity avatars may be associated with different elusiveness scores. Such elusiveness scores may relate to how hard or easy the celebrity avatar is to identify (described below) and/or how effective the celebrity avatar AI is at evading players. In some instances, one celebrity avatar may require more energy to initiate a chase than another celebrity avatar.

During gameplay, game module 204 may cause an expandable grid map to be displayed to a player. The grid map may indicate where the celebrity avatars are in relationship to the player's location in the virtual world. Clicking on particular celebrity avatar's location may cause game module 204 to provide a brief biography of the celebrity and a reward (e.g., game credits) players will receive for completing the task.

Navigating the Virtual World

After choosing a celebrity, game module 204 may cause indications of the direction that the player must guide their avatar to in order to intercept the chosen celebrity avatar to be provided to the player (e.g., through the player's device). In this manner, the player may be informed of where to direct their avatar through the virtual world to intercept a celebrity avatar. The grid map may also indicate other player avatars who may be looking for the same celebrity avatar and players can choose an intercept course for the other player avatars as well.

Using the control screen (e.g., one illustrated in FIG. 5) the player can steer their avatar through the virtual world (which may be populated with other avatars looking for celebrities). Other types of inputs may be used as well, such as through virtual controls (e.g., swiping, tapping, tilting, shaking, pressing on a touch screen, and/or other types of hardware or software interfaces configured to receive a user input.

Game module 204 may access a player avatar's characteristics (e.g., speed, stamina, agility, etc.) and control the movement of the avatar through the virtual world accordingly. Additionally or alternatively, game module 204 may control the movement of the avatar through the virtual world based on items associated with the player's avatar (e.g., virtual shoes). In some instances, game module 204 may provide a player with an opportunity to use virtual transportation. Different types of virtual transportation may be available, each with its own set of characteristics (e.g., speed, agility, etc.). Each of these will be useful in different situations and each have their own characteristics, and amount required to operate them (e.g., required energy, game credits, real currency, and/or other value). Examples of virtual transportation include, without limitation, a skateboard, a bike, a car/taxi, a boat, and/or other virtual modes of transportation that the player may use to chase a virtual avatar in the virtual world.

Identifying Celebrity Avatars within the Virtual World

Virtual celebrities can be life-like facial and/or body representations of living or deceased celebrities (e.g., actors, singers, athletes, politicians, media personalities, public figures and/or any individual). Once a player's avatar is nearby a celebrity avatar in the virtual world, the player may be required to identify the celebrity avatar. A celebrity avatar may be identified by a graphical indication separate from or displayed in association with the celebrity avatar. For instance, a ‘Star’ (or other image, shape, etc.) floating above the celebrity avatar may be visible in the virtual world by players through the eyes of their player avatar. Such graphical indication may be more or less obvious (e.g., bigger/smaller, highlighted/not highlighted, etc.) depending on an elusiveness score of the celebrity avatar and/or game level being played.

In other implementations, a celebrity avatar may be identified by using different aspects of the celebrity avatar (e.g., not using a graphical indication separate from or displayed in association with the celebrity avatar). For example, the player may be required to rely on virtual facial, virtual clothing, virtual tattoos, or other distinguishing virtual feature of the celebrity avatar. In some instances, the game module 204 may provide, upon request and/or when a celebrity avatar is nearby (e.g., within a predetermined virtual proximity to a player avatar), an image of the celebrity avatar so that the player may be reminded of the appearance of the celebrity avatar being chased.

In either implementation, various alerts may be sent to the player to indicate that an celebrity avatar is nearby. These alerts may include, for example, visual alerts within the virtual world (e.g., an on-screen visual cue) or outside the virtual world (e.g., flashing light on a user device), audio alerts within or outside the virtual world (e.g., voice, music, or other sounds), tactile (e.g., vibration of the user's device), and/or other alert.

Celebrity Avatar AI

Once a celebrity avatar has been identified within the virtual world, a player may be required to get within a predefined virtual proximity of the celebrity avatar to complete the task (e.g., obtain a virtual autograph and/or selfie). The celebrity avatar may be programmed to avoid capture by evading the player's avatar. As described herein, the celebrity avatar (as well as other bots and obstacles) will be described as performing certain actions when, in fact, game module 204 programs computer system 110 to cause the celebrity avatar (and bots, obstacles, etc.) to perform such actions.

Outside of virtual buildings and other enclosures, the celebrity avatar may, according to predetermined rules, move about the virtual world and/or decide whether to enter enclosed areas (e.g., virtual buildings) to avoid capture. Such entry into enclosed areas and other evasive actions may be triggered when a player avatar is within a predefined proximity to the celebrity avatar. This predefined proximity may be larger or smaller depending on how elusive the celebrity is (e.g., the elusiveness score may be correlated with the predefined proximity) and/or what level is being played.

In some instances, the celebrity avatar may decide to enter certain enclosed areas over others. For instance, a more elusive celebrity avatar may enter an enclosed area with more hiding spaces/obstacles and a less elusive celebrity avatar may enter another enclosed area with less hiding spaces/obstacles. The level being played may affect this behavior as well or in the alternative.

In some instances, once a player avatar enters into an enclosed area to chase a celebrity avatar, the player avatar may be placed in a one-on-one chase with the celebrity avatar. For example, while bots, obstacles, etc., may be in the enclosed area, other player avatars are not permitted to enter. In other instances, other players may enter the enclosed area to compete within the enclosed area.

In some instances, a celebrity avatar may move within the virtual world based on its elusiveness score. For instance, a more elusive celebrity avatar may be able to hide behind certain obstacles more effectively than a less elusive celebrity avatar. Furthermore, a celebrity avatar may be able to execute more or less escape vectors based on its elusiveness score or game level being played. For example, celebrity avatars may, based on predefined rules, be able to determine one or more escape vectors. Each escape vector may define a path through at least a portion of the virtual world that is unimpeded by an obstacle or player avatars such that, if taken, would allow the celebrity avatar to escape from a player avatar (assuming that the player avatar does not intervene and close off the escape vector). For example, a more elusive celebrity avatar may be able to execute/find a larger number of escape vectors while a less elusive celebrity avatar may be limited to finding a smaller number of vectors to choose from. Likewise, if a more elusive celebrity avatar may be able to take advantage of a lesser number of available escape vectors than a less elusive celebrity avatar. For instance, a more elusive celebrity avatar may escape capture if three escape vectors are available while a less elusive celebrity avatar may require at least five escape vectors to be available.

In some implementations, a celebrity avatar may employ virtual disguises that modify the appearance of the celebrity avatar. Such virtual disguises may be more or less elaborate (or non-existent) based on the elusiveness score of the celebrity avatar (in these instances, a player may be required to look carefully in the virtual world—the player will know the disguised celebrity avatar may be nearby due to the map or other indication).

In some implementations, a celebrity avatar may employ virtual transportation to help themselves evade capture. Such use (or non-use) of virtual transportation (and the type of virtual transportation used) may be based on the elusiveness score of the celebrity avatar.

In some implementations, a celebrity avatar may employ virtual security personnel that impede the player's avatar. The number of virtual security personnel and level of impedance from such virtual security may vary based on the elusiveness score of the celebrity avatar. Although some examples described herein describe elusiveness of the celebrity avatar based on the elusiveness score of the celebrity avatar, such elusiveness of any of the foregoing examples may also or instead be based on the level being played, skill of the player, and/or other information. Furthermore, although a celebrity avatar is described be associated with an elusive score, a given celebrity avatar may be associated with different elusiveness scores as well. For instance, a given celebrity avatar may appear in different levels, each level being associated with

Competing Against Players

In an implementation, game module 204 may permit a player to use certain virtual items to gain an advantage over other players. For instance, game module 204 may permit player to use the flash from their player avatar's virtual camera to temporarily “blind” other player avatars when chasing celebrity avatars. Such use may be limited and may need to be replenished by visiting virtual businesses, interacting with ads, using game credits, purchasing additional uses using real currency, and/or performing other action. In some instances, the effects of the virtual flash or other advantage may be variable. For instance, one virtual camera may cause a five second blinding while another virtual camera may cause an eight second blinding. In implementations in which a player avatar is temporarily blinded by another player avatar's flash, the blinded avatar may receive additional energy from the attacking avatar.

In some instances, during the time in which a player avatar is blinded, the player avatar may continue to interact with the virtual world, but be prohibited from chasing a celebrity avatar.

In some instances, during the time in which a player avatar is blinded, the player may not be allowed to interact with the virtual world, but instead be provided with alternative content (e.g., an advertisement, a mini-game, etc.).

Game module 204 may provide other types of advantages that may be used by players as well (or in addition). For instance, game module 204 may provide a player avatar with virtual items that can be thrown at another player avatar (e.g., a virtual banana peel that causes the other virtual avatar to slip and fall—the severity of which may vary), a virtual distraction such as a visual depiction of game credits (or other item of real or perceived value) that can be left behind to entice another player avatar to pause to pick up the game credits, and/or other types of advantages.

Bot and Virtual Object Management

In addition to other player avatars, bots and virtual obstructions may impede a player avatar's pursuit of a celebrity avatar. A bot may include a computer-controlled avatar. A bot may be distinguished from player avatars using a graphical or other indication. In some instances, another (competing) player avatar may be associated with a graphical or other indication to distinguish it from a bot (and bots may have no such indications). An obstruction may be in the form of a virtual object such as a virtual vehicle, a virtual animal, a virtual box, a virtual door, and/or other virtual objects that may appear in the virtual world. Virtual obstructions may be stationary or move about the virtual world.

Such bots and virtual obstructions may become more plentiful and/or intrusive at higher game levels. For instance, a given bot may track and follow movements of a player avatars more effectively at higher levels. A given obstacle may be larger and/or move about more quickly or erratically at higher levels.

In some instances, a number of bots may appear randomly. The frequency of such random appearance may vary based on different difficulty levels and/or elusiveness scores of celebrity avatars being chased. For instance, for more difficult levels and/or elusive celebrity avatars, game module 204 may cause more bots to appear.

In some instances, a player whose player avatar is impeded by a bot or obstruction may be imposed a penalty. For instance, if a player avatar touches or comes into a predefined proximity of a bot or virtual object, the player avatar may be stunned (as described herein) for a certain duration of time, the player controlling the player avatar may have energy, game credit, and/or other item of value deducted from the player's game account, the point value of capturing a celebrity avatar may be decreased, and/or other penalty imposed upon the player.

Capturing a Celebrity Avatar

In some instances, when a player avatar gets close enough to identify a celebrity, the game module 204 may automatically launch a mini movie or other multi-media. The mini movie may be different for different levels (e.g., each level may be associated with its own mini movie) and follow the player avatar and the celebrity avatar on foot and in exciting chase scenes in Cars, Boats, Airplanes, etc.

The mini movie may end when the player avatar follows a celebrity avatar into a virtual store or business (or other enclosed area) and the player resumes control of the player avatar's movements as the player attempts to capture (i.e. complete a task with respect to) the celebrity avatar.

The pursuit may end when the cornered celebrity avatar surrenders and lets the player have an autograph and take selfie-pictures (or conduct some other task) in association with the celebrity avatar. The player may then be provided with a reward, such as a number of game credits.

In some instances, the autographs and selfie-pictures may be posted to the player's Wall of Fame (which may be viewed in association with the virtual world) and their individual social media pages for their friends to see.

Players can proceed to the next game level and choose a better known and slightly more elusive celebrity to search for or check their game credit balance and browse the virtual store to redeem the game credits for gift cards, promotional items, discount coupons, and/or other items of perceived or real value. When a user visits a virtual store, the user may select goods and services from a list of categories or corporate logos. In some instances, when a particular product is selected by a user, the system may cause an advertisement or other promotional content to be provided to the user and provide redemption options to acquire the relevant item.

In an implementation, credits cannot be sold or traded between players, but can be donated to a world-wide network of pre-approved charitable organizations. Players can also elevate their V.I.P. Game Levels (indicative of their player standing, for example) by signing up for brief corporate surveys, product reviews and promotional specials.

The user module 206 may be configured to access and/or manage one or more user profiles and/or user information associated with users of the computer system 110. The one or more user profiles and/or user information may include information stored by computer system 110 (e.g., using database 160), one or more of the end user devices 140, and/or other storage locations. The user profiles may include, for example, language and preference filters specified by the player to determine who they want to see and who they want to be seen by in the virtual world, information identifying users (e.g., a username or handle, a number, an identifier, and/or other identifying information) within the virtual world, security login information (e.g., a login code or password), virtual world account information, subscription information, virtual currency account information (e.g., related to currency held in credit for a user), relationship information (e.g., information related to relationships between users in the virtual world), virtual world usage information, demographic information associated with users, interaction history among users in the virtual world, information stated by users, purchase information of users, browsing history of users, a client computing platform identification associated with a user, a phone number associated with a user, and/or other information related to users.

The space module 208 may be configured to implement the instance of the virtual world. Players may view the Avatar's virtual world perspective via the interactive Control Screen which displays the Action Commands, Game Information, Communication Options, Social Media Interfaces and Site Navigation. Players can choose not to chase celebrities and just socialize on the virtual streets and in virtual gatherings from computers thousands of miles away. Players can form Chat Rooms, Post Resumes and Jobs, Buy and Sell Merchandise, Crowd Source Funding, Dating and other social applications.

Customized instances of the Virtual World

In some instances, space module 208 may customize an instance of the virtual world specifically for a player. For example, the instance of the virtual world may be customized for a given player based on the player's age, location, gender, social media preferences, and/or other characteristics. In these instances, one player may be provided with a first instance of the virtual world that is different from a second instance of the virtual world provided to a second player, even though both players are playing (and potentially competing) in the same virtual world. A customized instance of the virtual world may include customized ads, spoken or written language, and/or other content or appearance of the virtual world.

The space module 208 may be configured to implement the instance of the virtual world executed by the computer modules to determine state of the virtual world. The state may then be communicated (e.g., via streaming visual data, via object/position data, and/or other state information) from computer system 110 to end user devices 140 for presentation to users. The state determined and transmitted to a given end user device may correspond to a view for a user character being controlled by a user via the given end user device. The state determined and transmitted to a given end user device 140 may correspond to a location in the virtual world. The view described by the state for the given client computing platform may correspond, for example, to the location from which the view is taken, the location the view depicts, and/or other locations, a zoom ratio, a dimensionality of objects, a point-of-view, and/or view parameters of the view. One or more of the view parameters may be selectable by the user.

The instance of the virtual world may comprise a simulated space that is accessible by users via devices (e.g., end user devices 140) that present the views of the virtual world to a user. The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space, and/or surface features of a surface or objects that are “native” to the space. In some instances, the topography may describe a surface (e.g., a ground surface) that runs through at least a substantial portion of the space. In some instances, the topography may describe a volume with one or more bodies positioned therein (e.g., a simulation of gravity-deprived space with one or more celestial bodies positioned therein). The instance executed by the computer modules may be synchronous, asynchronous, and/or semi-synchronous.

The above description of the manner in which state of the virtual world is determined by space module 208 is not intended to be limiting. The space module 208 may be configured to express the virtual world in a more limited, or more rich, manner. For example, views determined for the virtual world representing the state of the instance of the virtual world may be selected from a limited set of graphics depicting an event in a given place within the virtual world. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other expressions of individual places within the virtual world are contemplated.

Within the instance(s) of the virtual world executed by space module 208, users may control characters, objects, simulated physical phenomena (e.g., wind, rain, earthquakes, and/or other phenomena), and/or other elements within the virtual world to interact with the virtual world and/or each other. The user characters may include avatars. As used herein, the term “user character” may refer to an object (or group of objects) present in the virtual world that represents an individual user. The user character may be controlled by the user with which it is associated. The user controlled element(s) may move through and interact with the virtual world (e.g., non-user characters in the virtual world, other objects in the virtual world). The user controlled elements controlled by and/or associated with a given user may be created and/or customized by the given user. The user may have an “inventory” of virtual goods and/or currency that the user can use (e.g., by manipulation of a user character or other user controlled element, and/or other items) within the virtual world.

The users may participate in the instance of the virtual world by controlling one or more of the available user controlled elements in the virtual world. Control may be exercised through control inputs and/or commands input by the users through end user devices 140. The users may interact with each other through communications exchanged within the virtual world. Such communications may include one or more of textual chat, instant messages, private messages, voice communications, and/or other communications. Communications may be received and entered by the users via their respective end user devices 140. Communications may be routed to and from the appropriate users through computer system 110 (e.g., through space module 208).

The users may participate in the instance of the virtual world by controlling one or more of the available user controlled elements in the virtual world. Control may be exercised through control inputs and/or commands input by the users through end user devices 140. The users may interact with each other through communications exchanged within the virtual world. Such communications may include one or more of textual chat, instant messages, private messages, voice communications, and/or other communications. Communications may be received and entered by the users via their respective end user devices 140. Communications may be routed to and from the appropriate users through computer system 110.

Interactive, electronic social media may include one or more of a social network, a virtual world, a micro-blogging service, a blog service (or host), a browser-based game, a multi-player mobile game, a file (e.g., image file, video file, and/or other files) sharing service, a messaging service, a message board, a forum, and/or other electronically distributed media that are scalable and enable interaction between the users. Some non-limiting specific examples of interactive, electronic social media may include the micro-blogging service provided by Twitter™, the social network provided by Facebook™, the social network provided by MySpace™, the social network provided by Foursquare®, the virtual world provided by SecondLife®, the massively multi-player online game provided by World of Warcraft®, the file sharing service provided by Flickr®, Blogger, YouTube, PlayStation® Home, Xbox® Live, and/or other interactive electronic social media.

2-Dimensional Implementations

In some implementations, although described herein with respect to a three-dimensional virtual world game, the celebrity chase virtual world game may be implemented as a two-dimensional top-down or side scrolling game. For instance, instead of controlling a player avatar in a three-dimensional virtual world, the player may control the player avatar to chase celebrity avatars and/or avoid bots and obstructions from a top-down or side-scrolling gameplay orientation. In these implementations, gameplay mechanics may be similar to that described with respect to a three-dimensional implementation, except that control of the avatar will be in a two-dimensional virtual space rather than a three-dimensional virtual space. This may lend itself to more casual gameplay. In some instances, space module 108 may allow for the selection of either two-dimensional or three-dimensional gameplay. In this manner, a player may elect to choose to play the two-dimensional version and later choose to play the three-dimensional version later, while maintaining the same game account, allowing for gameplay for either version while retaining previous scores, accounts, etc.

Various Perspectives of Gameplay

Different perspectives of gameplay may be used. For instance, a first person, second person, or third person perspective may be used to instantiate the virtual world for gameplay by one or more users.

In a First Person perspective, gameplay may be provided from the player's point of view to see the Virtual World through the eyes an avatar. In a Second Person perspective, gameplay may be provided from the view of another player. In a Third Person perspective, gameplay may be provided from a Top Down or Over the Shoulder perspective that follows the Avatar from variety of selectable camera angles and allows the player to see the virtual environment from variety of a selectable distances.

The interaction module 210 may be configured to monitor interactions of the users with the virtual world and/or each other within the virtual world. This may include monitoring, for a given user, one or more of times at which the given user is logged in to the virtual world, areas of the virtual world the given user views or interacts with or in, other users the given user interacts with, the nature and/or content of interactions of the given user with other users, activities participated in within the virtual world, level, powers, or skill attained in the virtual world, inventory items obtained in the virtual world, and/or other interactions of the given user with the virtual world and/or other users. Some or all of the information generated by interaction module 210 in monitoring the interactions of the users may be stored to the user profiles managed by user module 206.

At a given time, interaction module 210 may determine a set of users that are currently engaged with the virtual world and/or a set of users that are currently not engaged with the virtual world. Being engaged with the virtual world may refer to being logged in to the virtual world, performing some action or interaction within the virtual world within some period of time (e.g., the last 2 minutes), and/or other taking some other action indicating ongoing and contemporaneous engagement with the virtual world.

The interaction module 210 may be configured to determine, for individual users, an activity metric that indicates an activity level within the virtual world. The activity metric may be determined based on a number of attempted celebrity chases, a duration of time of one or more celebrity chases, one or more of log in frequency, amount of time logged in to the virtual world within a rolling time period (e.g., over the last day, week, month, or other rolling time period), average amount of time logged in to the virtual world over some length of time (e.g., per day, per week, and/or other length of time), average log in session time over a rolling time period, number of inter-user communications over a length of time, number of inter-user communications per log in, number of relationships with other users in the virtual world, number of new relationships with other users in the virtual world within a rolling time period, amount of real world money spent in the virtual world, and/or other activity parameters.

The relationship module 212 may be configured to establish relationships between users within the virtual world. Such relationships may include one or more of friendships, guilds (with guild-mates), alliances, connections, followers, and/or other relationships. The relationship module 212 may establish relationships based on relationship requests and acceptances received from users. Establishment of a relationship may be initiated by a single communication (e.g., a request) initiated by a given user requesting a relationship between the given user and one or more other users. Establishment of a relationship may require a first communication from the given user to be approved by the one or more other users. Relationships may include one or more types of relationships that have a functional purpose or impact within the virtual world, and/or one or more types of relationships that a social construct within the virtual world that does not have a functional result.

The relationship module 212 may allow players to set parameters to control who is visible in their Virtual Reality Environment and if players only want people of a certain Age, Gender or Region (or other filters) used to determine whether to block or permit interaction with certain individuals. The relationship module 212 may maintain a ‘Friend's List’ that indicates where other players they are already familiar with are located in the virtual world and allow them to send a text message using the Language Translator or call them directly with Voice-Over IP.

Communication module 214 may facilitate players sending instant text messages and friend requests to each other from anywhere in the world no matter what language they speak using a Language Translation Program which understands linguistic intentions.

E-commerce module 216 may facilitate purchases made in association with the virtual chase game. For example, a user may purchase energy or other in-game items (e.g., stronger virtual flash, shoes with higher performance, faster avatar, etc.). E-commerce module 216 may facilitate the debiting of real currency from the player's real financial account to a real financial account associated with an operator of computer system 110.

In some instances, e-commerce module 216 may facilitate purchases between a player and a business having a virtual business in the virtual world. For instance, a player avatar may enter a virtual business and make a purchase. The purchase may be for a virtual item (in which case the player avatar may use the virtual item in the virtual world) or for a real item offered by the business, in which case e-commerce module 216 may facilitate the exchange of payment information and delivery or availability of the purchased real item.

In an implementation, e-commerce module 216 may facilitate interactions between real businesses or organizations that have virtual storefronts and real customers through their player avatars in the virtual world. For example, businesses in organizations may be able to communicate in real time to players via the Voice-Over IP, text message with the language translation, and/or other communication channel. When a player avatar enters a virtual storefront and asks for additional information about a product or service, e-commerce module 216 may cause a company avatar that offers assistance. The company avatar may be controlled automatically using predefined rules or by a human customer service representative of the business or organization. E-commerce module 216 may provide brief surveys and prompts to provide customer service ratings. Players who provide responses may earn bonus energy, camera flashes (e.g., in implementations in which the use of virtual camera flashes or other virtual items to gain a competitive advantage is limited), and/or other item of real or perceived value.

In an implementation, advertising module 218 may provide ads within the virtual world. For example, advertising module 218 may obtain and store ads from various ad providers. Advertising module 218 may demographically target the ads to ensure that products and services are presented in local, regional and national markets to consumers who can relate to them and respond positively. Advertising module 218 may facilitate virtual Product Placements (Movies, Music, Fashion, Electronics, Cosmetics and Vehicles) Virtual Businesses & Store Fronts (Players Receive Energy For Entering,) Virtual Logos (Players receive credit for touching,) Pay Per Click (When Players ‘Click’ on Website,) Pay Per Metric (Pay Per 1000 Impressions,) Pay Per Fan (When Players click ‘Like’ on Ad,) 10 Second Audio-Visual Ads (watched regaining Energy) 5 Second Audio-Visual ‘Slogan’ Ads (Watched when they click on Logos and during time-outs) and Virtual Accessories (Clothes, Jewelry, Improved Skills and Pets) that Players can purchase to enhance their experience.

Accounting module 220 may store financial account information associated with players, businesses, an operator of computer system 110, advertisers, and/or other entities. Accounting module 220 may cause funds to be transferred from one financial account to another financial account based on purchases made, ads served, and/or other transactions.

In some instances, real celebrities may agree to be the subject of a celebrity chase (i.e., be added to the virtual chase game). In these instances, a celebrity avatar may be created for the real celebrity. While in some implementations, the only celebrity compensation is a fan connection if they are “captured”—adding to the celebrity's social or other fanbase—in other implementations, the celebrity may be monetarily compensated as well or in addition. In these implementations, accounting module 220 may cause funds to be transferred to a financial account of the celebrity based on a number of initiated chases, successful chases/selfies pinned, and/or other actions.

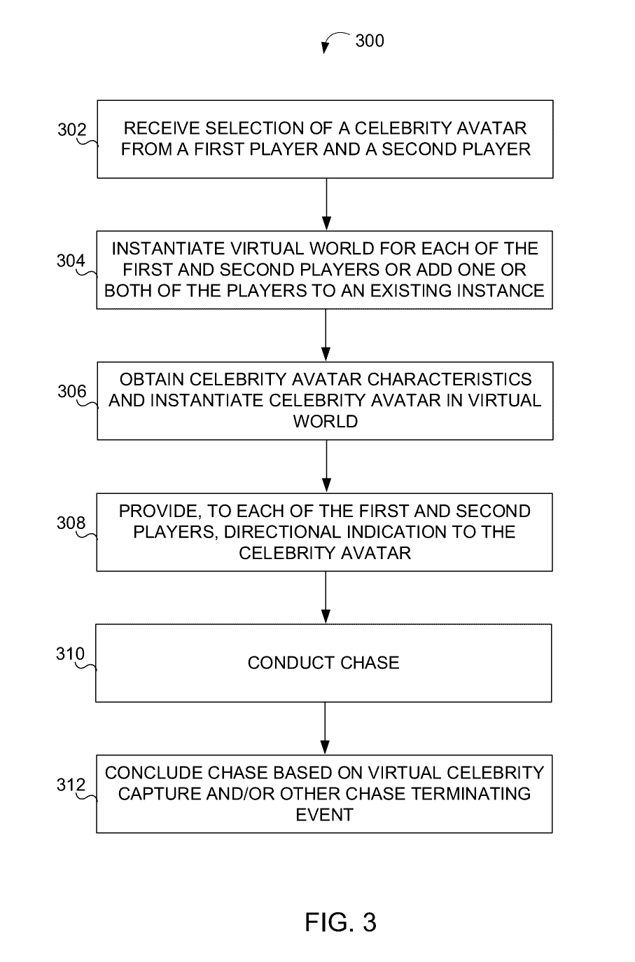

FIG. 3 illustrates a process 300 for providing a celebrity chase virtual world game, according to an implementation of the invention.

In an operation 302, process 300 may include receiving a selection of a celebrity avatar from a first player and a second player. The selections may be independently received (e.g., the first player separately selected the celebrity avatar to chase and the second player also separately selected the celebrity avatar to chase) or together received (e.g., the first player and the second player agree to compete against one another to chase the celebrity avatar).

In an operation 304, process 300 may include instantiating a virtual world for each of the first and second players or adding one or both of the first and second players to an existing virtual world that is already instantiated (e.g., for one or more other players). In some implementations, each instance of the virtual world is customized for a particular player. For example, the first player's instance of the virtual world may be localized according to a geographic region (and therefore include a particular language) while the second player's instance of the virtual world may be localized according to another geographic region (and therefore include another language). Other types of customizations may be made as well so that each player is provide with its own instance of the virtual world. In other implementations, the instance of the virtual world is the same for the first player and the second player. In still other implementations, some players may be provided with the same instance of the virtual world while other players may each be provided with a customized instance of the virtual world.

In an operation 306, process 300 may include obtaining one or more celebrity avatar characteristics and instantiating the celebrity avatar based on the characteristics. The celebrity avatar characteristics may include, without limitation, an elusiveness score (and/or corresponding rules for evading capture), appearance of the celebrity avatar, and/or other characteristics. Likewise, a first player avatar and a second player avatar may be respectively instantiated for the first player and the second player. Process 300 may include placing the celebrity avatar, first player avatar, and second player avatar in the virtual world. The first player avatar and the second player avatar may be placed within close proximity of one another in the virtual world or in different parts of the virtual world. Such initial placement may be selected by each user and/or be determined by process 300 (e.g., randomly or otherwise).

In an operation 308, process 300 may include providing, to each of the first and second players, one or more direction indications that provide directions to the celebrity avatar. For instance, a direction indication may include an arrow that is displayed (either in or outside of a view of the virtual world) that indicates where a player should navigate its player avatar through the virtual world to intercept the celebrity avatar. Alternatively or additionally, an expandable grid map may be provided to the players. The grid map may indicate locations of the celebrity avatar and any player avatars that are chasing the celebrity avatar.

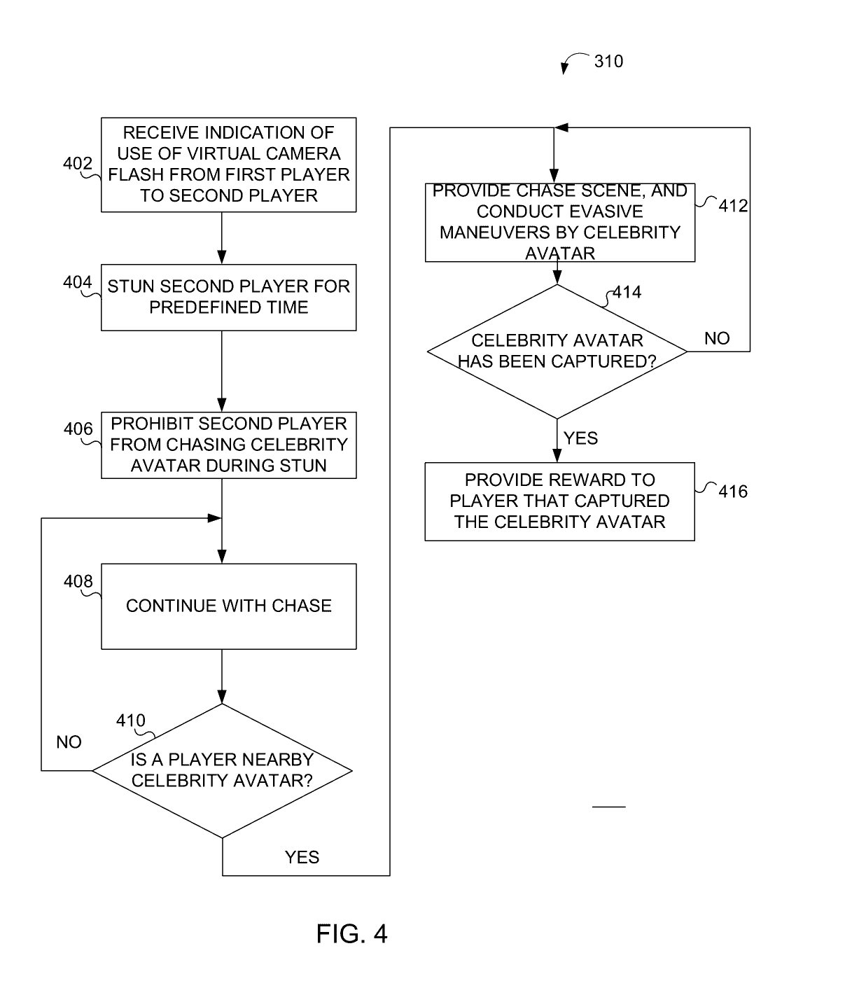

In an operation 310, process 300 may include conducting the chase. The chase may include competition amongst the first and second players (including use of virtual camera flashes to stun opposing player avatars), interference from computer-controlled bots, obstacles, and other impedences, evasive actions from the celebrity avatar, and/or other game aspects. An example of a chase is disclosed in more detail with respect to FIG. 4.

In an operation 312, process 300 may include concluding the chase based on a determination that the virtual celebrity has been captured and/or other chase terminating event. In some instances, the chase may end when a player first captures the celebrity avatar. In other instances, the chase may continue so that other players may also capture the celebrity avatar (which may be at a reduced reward). In some implementations, the chase terminating event may include an expiration of an allotted amount of time to capture the celebrity avatar. Combinations of terminating events may be used as well, such use of an expiration time or when a player first captures a celebrity avatar, whichever occurs first. Other combinations may include use of an expiration time or when all players capture the celebrity avatar, whichever occurs first.

Although described with respect to a celebrity avatar being chased during a game, multiple celebrity avatars may be chased (e.g., instantiated into an instance of the virtual world) so that more than one celebrity avatar may be chased during a given game. Such multiple celebrity avatars may be chased together (e.g., the celebrity avatars may be configured as friends that are together in the virtual world) and/or separately (e.g., the celebrity avatars may split up or otherwise be independently/separately computer-controlled). Furthermore, in some implementations, the celebrity avatar may be controlled by a human (e.g., an actual celebrity for whom the celebrity avatar represents or other player) in certain game modes.

FIG. 4 illustrates a process 310 for conducting a chase in a celebrity chase virtual world game, according to an implementation of the invention.

In an operation 402, process 310 may include receiving an indication of the use of a virtual camera flash by a first player against a second player (or a game-controlled bot). Alternatively or additionally, the use of other competitive actions (e.g., use of virtual banana peel) may be indicated.

In an operation 404, process 310 may include stunning the second player responsive to the indication.

For instance, the second player may not be permitted to continue chasing a celebrity avatar during a predetermined period of time (e.g., while the second player is stunned) in an operation 406. In some instances, the second player may be provided with alternative content (e.g., an ad) during the predetermined period of time. In some instances, process 310, prior to stunning the second player, process 310 may include determining whether the first player aimed the virtual camera flash in an appropriate direction or within a predetermined flash range necessary for the flash to be effective. For example, process 310 may determine whether the virtual camera flash missed the second player avatar (or a game-controlled bot). If so, no stunning may occur, but the first player may still lose the fee associated with using the virtual camera flash (for implementations in which a limited number of uses of the virtual camera flash or other competitive action is permitted or otherwise when a player must pay some real or virtual item of value to use the virtual camera flash or other competitive action).

In an operation 408, process 310 may include resuming the chase.

In an operation 410, process 310 may include determining whether a player avatar is nearby a celebrity avatar, as determined from a threshold virtual distance between the player avatar and the celebrity avatar in the virtual world.

In an operation 412, responsive to a determination that the player avatar is nearby the celebrity avatar, process 310 may include providing a chase scene. In some instances, the chase scene may include video depicting the player avatar chasing the celebrity avatar. In some of these instances, the player may not be able to control the player avatar until the chase scene has completed. The player may, in some instances, skip the chase scene to continue controlling the player avatar. Process 310 may include causing the celebrity avatar to take evasive actions, such as hiding behind virtual obstacles or bots, employing virtual security personnel, and/or taking other actions to evade capture.

In an operation 414, process 310 may include determining whether the celebrity avatar has been captured. Such determination may be based on whether any escape vectors exists, the number of escape vectors, whether any capture terminating event has occurred, and/or other information that indicates that the celebrity avatar has been captured.

FIG. 5 illustrates a screen shot of a control screen 500 for navigating within a celebrity chase virtual world game, according to an implementation of the invention.

Control screen 500 may be displayed by end user device 140. Control screen 500 displays an instance of the virtual world provided by computer system 110. Control screen 500 may display various controls (e.g., “clap,” “high five,” “open arms,” “thumb up,” “thumb down,” “frown,” “mouth fire,” “ear smoke,” “point finger,” “sit,” “dance,” “zoom,” “laugh,” “wave,” “smile,” “go home,” “game level,” “energy meter,” “gift shop,” “change view,” “friends online,” “camera,” “autograph,” “look L&R,” “run,” “walk,” “look U&D,” “look behind,” “grid map,” “text message,” directional controls, and/or other controls that are configured to receive user input. A player may control his player avatar 520 using control screen 500 using one or more of the illustrated or other controls.

As illustrated, a celebrity avatar 510 is depicted along with a graphical indicator 512 that indicates a location of the celebrity avatar. Player avatar 520 may be associated with a corresponding facial shot 522 of the player avatar. An expandable grid map 530 may display a relative location 532 of a celebrity avatar, a relative location 534 of player avatar 520 and a relative location 536 of another player avatar.

Illustration of computer system 110 in FIG. 1 is not intended to be limiting. The computer system 110 may include a plurality of hardware, software, and/or firmware components operating together to provide the functionality attributed herein to computer system 110. For example, computer system 110 may be implemented by a cloud of computing platforms operating together as computer system 110.

Storage device 114, 144 may comprise electronic storage media that electronically stores information. The electronic storage media of storage device 114, 144 may include one or both of system storage that is provided integrally (i.e., substantially non-removable) with computer system 110/end user device 140 and/or removable storage that is removably connectable to computer system 110/end user device 140 via, for example, a port (e.g., a USB port, a firewire port, etc.) or a drive (e.g., a disk drive, etc.). Storage device 114, 144 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The storage device 114, 144 may include one or more virtual storage resources (e.g., cloud storage, a virtual private network, and/or other virtual storage resources). Storage device 114, 144 may store software algorithms, information determined by processor 112, 142, information received from computer system 110, information received from end user device 140, and/or other information that enables computer system 110 or end user device 140 to function as described herein.

Processor(s) 112 is configured to provide information processing capabilities in computer system 110. Processor(s) 142 is configured to provide information processing capabilities in end user device 140. As such, processor 112, 142 may include one or more of a digital processor, an analog processor, a digital circuit designed to process information, an analog circuit designed to process information, a state machine, and/or other mechanisms for electronically processing information. Although processor 112, 142 is shown in FIG. 1 as a single entity, this is for illustrative purposes only. In some implementations, processor 112, 142 may include a plurality of processing units. These processing units may be physically located within the same device, or processor 112, 142 may represent processing functionality of a plurality of devices operating in coordination. The processor 112 may be programmed with celebrity chase host application 116 using software; hardware; firmware; some combination of software, hardware, and/or firmware; and/or other mechanisms for configuring processing capabilities on processor 112. Likewise, processor 142 may be programmed using celebrity chase client application 146 using software; hardware; firmware; some combination of software, hardware, and/or firmware; and/or other mechanisms for configuring processing capabilities on processor 142.

The description of the functionality provided by the different modules 202-220 described below is for illustrative purposes, and is not intended to be limiting, as any of modules 202-220 may provide more or less functionality than is described. For example, one or more of modules 202-220 may be eliminated, and some or all of its functionality may be provided by other ones of modules 202-220. As another example, processor 112 may be programmed with one or more additional modules that may perform some or all of the functionality attributed below to one of modules 202-220.

In some embodiments, the processes illustrated in FIGS. 3 and 4 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the illustrated operations in response to instructions stored electronically on an electronic storage medium. The one or more processing devices may include one or more devices configured through hardware, firmware, and/or software to be specifically designed for execution of one or more of the operations of the process. The described operations are intended to be illustrative and not limiting. In some embodiments, the process may be accomplished with one or more additional operations not described, and/or without one or more of the operations discussed. Additionally, the order in which the operations of the process is not intended to be limiting.

The screenshot illustrated in FIG. 5 are for illustrative purposes only. Various user interface components may be added, deleted, moved, or otherwise changed so that the configuration, appearance, and/or content of the screenshots may be different than as illustrated in the figures. Accordingly, the graphical user interface objects as illustrated (and described in greater detail below) are exemplary by nature and, as such, should not be viewed as limiting.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A computer implemented method for providing a celebrity chase virtual world game, the method being implemented on a computer system having one or more physical processors programmed with computer program instructions that, when executed by the one or more physical processors, program the computer system to perform the method, the method comprising:
generating, by the computer system, an instance of a virtual world in which a celebrity chase occurs;
placing, by the computer system, an instance of a celebrity avatar that represents a celebrity into the instance of the virtual world;
placing, by the computer system, an instance of a first player avatar that represents a first player into the instance of the virtual world;
placing, by the computer system, an instance of a second player avatar that represents a second player into the instance of the virtual world;
receiving, by the computer system, an input from the first player to activate a virtual camera flash in the vicinity of the second player avatar;
causing, by the computer system, the virtual camera flash to be directed toward the second player avatar;
causing, by the computer system, the second player avatar to be impeded from pursuing the celebrity avatar for a predetermined duration of time responsive to the virtual camera flash;
determining, by the computer system, whether that the first player avatar is within a predetermined proximity of the celebrity avatar in the instance of the virtual world;
causing, by the computer system, the celebrity avatar to take one or more evasive actions to evade the first player responsive to the determination that the first player avatar is within the predetermined proximity of the celebrity avatar;
determining, by the computer system, that the one or more evasive actions are sufficient to evade the first player;
and
responsive to the determination that the one or more evasive actions are sufficient, causing, by the computer system, the celebrity avatar to escape.

2. The method of claim 1, the method further comprising:
determining, by the computer system, that the first player avatar is within a second predetermined proximity of the celebrity avatar in the instance of the virtual world;
causing, by the computer system, the celebrity avatar to take one or more evasive actions to evade the first player responsive to the determination that the first player avatar is within the second predetermined proximity of the celebrity avatar;
determining, by the computer system, that the one or more evasive actions are not sufficient to evade the first layer;
responsive to the determination that the one or more evasive actions are not sufficient, causing, by the computer system, the celebrity avatar to be captured,
wherein causing the celebrity avatar to be captured comprises causing a reward to be provided to the first player.

3. The method of claim 1, the method further comprising:
causing, by the computer system, one or more directional indicators to be displayed to the first player, wherein the one or more directional indicators indicate a direction from the first player avatar in the instance of the virtual world to the celebrity avatar in the instance of the virtual world.

4. The method of claim 1, wherein causing the second player avatar to be impeded from pursuing the celebrity avatar for the predetermined duration of time comprises causing, by the computer system, an advertisement to be displayed to the second player.

5. The method of claim 1, wherein causing the second player avatar to be impeded from pursuing the celebrity avatar for the predetermined duration of time comprises causing, by the computer system, allowing the second player avatar to continue to interact with the instance of the virtual world but preventing the second player avatar from pursuing the celebrity avatar.

6. The method of claim 1, the method further comprising:
receiving, by the computer system, from a first end user device, a voice input spoken by the first player;
obtaining, by the computer system, one or more words determined from the voice input;
determining, by the computer system, that the one or more words correspond to a word associated with a motion or gesture; and
causing, by the computer system, the motion or gesture to be performed by the first player avatar in the instance of the virtual world responsive to the determination that the one or more words correspond to the word associated with the motion or gesture.

7. The method of claim 6, wherein the motion or gesture comprises a nod in response to the one or more words comprising the word “yes.”

8. The method of claim 1, the method further comprising:
causing, by the computer system, a celebrity indicator to be displayed in association with the celebrity avatar responsive to a determination that the first player avatar is within the predetermined proximity of the celebrity avatar.

9. The method of claim 1, wherein the celebrity avatar is associated with an elusiveness score that indicates a level of evasiveness of Which the celebrity avatar is capable.

10. The method of claim 9, wherein the level of evasiveness of which the celebrity avatar is capable is based further on a game level being played.

11. The method of claim 10, the method thrther comprising:
placing, by the computer system, one or more bots that impede the progress of the first player avatar or the second player avatar from capturing the celebrity avatar, wherein the activity of the one or more bats is based on the elusiveness score and/or the game level being played.

12. The method of claim 11, wherein a number of the one or more bots that are placed is based on the elusiveness score and/or the game level being played.

13. The method of claim 1, the method further comprising:
placing, by the computer system, one or more obstacles that impede the first player avatar or the second player avatar from capturing the celebrity avatar.

14. (canceled)

15. The method of claim 1, wherein generating an instance of a virtual world in which the celebrity chase occurs comprises:
generating, by the computer system, a first instance of the virtual world customized for the first player; and
generating, by the computer system, a second instance of the virtual world customized for the second player, wherein the first instance of the virtual world and the second instance of the virtual world each have unique characteristics with respect to one another so that a view of the virtual world provided to the first player is different than a view of the virtual world provided to the second player.

16. A system for providing a celebrity chase virtual world game, the system comprising:
a computer system comprising one or more physical processors programmed with computer program instructions that, when executed by the one or more physical processors, program the computer system to:
generate an instance of a virtual world in which a celebrity chase occurs;
place an instance of a celebrity avatar that represents a celebrity into the instance of he virtual world;
place an instance of a first player avatar that represents a first player into the instance of the virtual world;
place an instance of a second player avatar that represents a second player into the instance of the virtual world;
receive an input from the first player to activate a virtual camera flash in the vicinity of the second player avatar;
cause the virtual camera flash to be directed toward the second player avatar;
cause the second player avatar to be impeded from pursuing the celebrity avatar for a predetermined duration of time responsive to the virtual camera flash;
determine that the first player avatar is within a predetermined proximity of the celebrity avatar m the instance of the virtual world;
cause the celebrity avatar to take one or more evasive actions to evade the first player responsive to the determination that the first player avatar is within the predetermined proximity of the celebrity avatar;
determine that the one or more evasive actions are sufficient to evade the first player;
responsive to the determination that the one or more evasive actions are sufficient, cause the celebrity avatar to escape.

17. The system of claim 16. wherein the computer system is further pro rammed to;
determine that the first player avatar is within a second predetermined proximity of the celebrity avatar in the instance of the virtual world;
cause the celebrity avatar to take one or more evasive actions to evade the first player;
responsive to the determination that the first player avatar is within the second predetermined proximity of the celebrity avatar;
determine that the one or more evasive actions are not sufficient to evade the first player;
responsive to the determination that the one or more evasive actions are not sufficient, cause the celebrit avatar to be captured, wherein to cause the celebrity avatar to be captured, the computer system is programmed to: cause a reward to be provided to the first player.

18. The system of claim 16, wherein the computer system is further programmed to:
cause one or more directional indicators to be displayed to the first player, wherein the one or more directional indicators indicate a direction from the first player avatar in the instance of the virtual world to the celebrity avatar in the instance of the virtual world.

19. The system of claim 16, wherein to cause the second player avatar to be impeded from pursuing the celebrity avatar for the predetermined duration of time, the computer system is programmed to cause an advertisement to be displayed to the second player.

20. The system of claim 16, wherein to cause the second player avatar to be impeded from pursuing the celebrity avatar for the predetermined duration of time, the computer system is programmed to cause allowing the second player avatar to continue to interact with the instance of the virtual world but preventing the second player avatar from pursuing the celebrity avatar.

21. The system of claim 16, wherein the computer system is further programmed to:
receive, from a first end user device, a voice input spoken by the first player; obtain one or more words determined from the voice input;
determine that the one or more words correspond to a word associated with a motion or gesture; and
cause the motion or gesture to be performed by the first player avatar in the instance of the virtual world responsive to the determination that the one or more words correspond to the word associated with the motion or gesture.

22. The system of claim 21, wherein the motion or gesture comprises a nod in response to the one or more words comprising the word “yes.”

23. The system of claim 16, wherein the computer system is further programmed to:
cause a celebrity indicator to be displayed in association with the celebrity avatar responsive to a determination that the first player avatar is within the predetermined proximity of the celebrity avatar.

24. The system of claim 16, wherein the celebrity avatar is associated with an elusiveness score that indicates a level of evasiveness of which the celebrity avatar is capable.

25. The system of claim 24, wherein the level of evasiveness of which the celebrity avatar is capable is based further on a game level being played.

26. The system of claim 25, wherein the computer system is further programmed to:
place one or more hots that impede the progress of the first player avatar or the second player avatar from capturing the celebrity avatar, wherein the activity of the one or more bots is based on the elusiveness score and/or the game level being played.

27. The system of claim 26, wherein a number of the one or more hots that are placed is based on the elusiveness score and/or the game level being played.

28. The system of claim 16, wherein the computer system is further programmed to:
place one or more obstacles that impede the first player avatar or the second player avatar from capturing the celebrity avatar.

29. (canceled)

30. The system of claim 16, wherein to generate an instance of a virtual world in which the celebrity chase occurs, the computer system is programmed to:
generate a first instance of the virtual world customized for the first player; and
generate a second instance of the virtual world customized for the second player, wherein the first instance of the virtual world and the second instance of the virtual world each have unique characteristics with respect to one another so that a view of the virtual world provided to the first player is different than a view of the virtual world provided to the second player.

31. A computer implemented method for providing a celebrity chase virtual world game, the method being implemented on a computer system having one or more physical processors programmed with computer program instructions that, when executed by the one or more physical processors, program the computer system to perform the method, the method comprising:
generating, by the computer system, an instance of a virtual world in which a celebrity chase occurs;
placing, by the computer system, an instance of a celebrity avatar that represents a celebrity into the instance of the virtual world;
placing, by the computer system, an instance of a first player avatar that represents a first player into the instance of the virtual world;
determining, by the computer system, that the first player avatar is within a predetermined proximity of the celebrity avatar in the instance of the virtual world;
causing, by the computer system, the celebrity avatar to take one or more evasive actions to evade the first player responsive to a determination that the first player avatar is within the predetermined proximity of the celebrity avatar;
determining, by the computer system, that the one or more evasive actions are not sufficient to evade the first player; and
responsive to the determination that the one or more evasive actions are not sufficient, causing, by the computer system, the celebrity avatar to be captured.

32. The system of claim 31, wherein the computer system is programmed to:
host the virtual world via a network for a first end user device associated with the first player.

33. The system of claim 32, wherein the first end user device comprises a virtual reality headset that includes one or more sensing controls that detect a motion of the first player to control the first player avatar in the virtual world.

34. The system of claim 32, wherein the first end user device comprises a virtual reality headset that includes one or more sensing controls that detect a motion of the first player to control the first player avatar in the virtual world.

35. The system of claim 32, wherein the computer system is further programmed to:
generate an image of the first player avatar and the celebrity avatar responsive to the determination that the one or more evasive actions are not sufficient; and
interface with a social media platform via the network and provide the generated image to be posted to a social media account of the first player hosted at the social media platform.
